(19) United States
(12) Patent Application Publication
(10) Pub. No.: US 2008/0283718 A1
(43) Pub. Date: Nov. 20, 2008

(54) Vibration control supporter

(75) Inventor: Shigeto Tsuge, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/081,074

(22) Filed: Apr. 10, 2008

(30) Foreign Application Priority Data
May 15, 2007 (JP) 2007-129693

(51) Int. Cl. F16M 13/00

(52) U.S. Cl. 248/562

(57) ABSTRACT

A vibration control supporter includes a rod shaped screwing body screwed into a fixing member, an upper elastic support part at a side of the screwing body away from the member, and a lower elastic support part at a side of the screwing body close to the member. The upper part joins the screwing body and the device by an upper elastic body. The lower part joins the screwing body and the device by a lower elastic body. Turning force of the screwing body is transmitted to the upper body. The lower part includes a collar inserted into the lower body. The collar has an insertion hole, through which the screwing body passes. A clearance for canceling a tolerance is formed between a loosely fitted portion of the hole and the screwing body. A movement restricting portion of the hole contacts the screwing body to prevent movement of the collar.

### CROSS REFERENCE TO RELATED APPLICATION

This application is based on and incorporates herein by reference Japanese Patent Application No. 2007-129693 filed on May 15, 2007.

### BACKGROUND OF THE INVENTION

1. Field of the Invention

The present invention relates to a vibration control supporter, which supports a valve device with its vibration controlled relative to a fixing member. The valve device has a valve port that is inserted into a valve insertion hole through a sealing member, and the valve insertion hole is formed in the fixing member.

2. Description of Related Art

A vibration control supporter conventionally supports a valve device with its vibration controlled relative to a fixing member (see e.g., JP-U-741160). More specifically, according to a conventional vibration control supporter, an elastic body (grommet) is attached to a stay (fixture tool) of an electromagnetic valve (an example of the valve device), and a bolt (an example of a rod-shaped screwing body) is passed through an insertion hole of the elastic body. The bolt is screwed and fixed to a suction member (an example of a fixing member: an intake manifold is hereafter illustrated as an example of the suction member) of an engine for vehicles, and the electromagnetic valve is supported by the intake manifold through the elastic body supported by the bolt.

When the electromagnetic valve is long in a direction in which a valve port (part inserted into the intake manifold) of the electromagnetic valve is inserted, or the electromagnetic valve is heavy, for example, great inclination force is generated in the electromagnetic valve due to vibration and load applied to a radial direction of the electromagnetic valve. When the elastic body is provided on a valve port insertion-side of the electromagnetic valve, that is, near the intake manifold, there is a concern that the electromagnetic valve is inclined because the great inclination force produced in the electromagnetic valve cannot be absorbed in the elastic body. When the electromagnetic valve is inclined, the valve port of the electromagnetic valve is brought into contact with an inner wall of a valve insertion hole formed in the intake manifold. As a result, the malfunction of transmission of an operating sound of the electromagnetic valve to the intake manifold is caused.

In JP-U-741160, a position of a female screw into which the bolt is screwed is brought close to the center of gravity of the electromagnetic valve in order to bring an attachment position of the elastic body close to the center of gravity of the electromagnetic valve. However, the shape of the intake manifold becomes complicated to bring the female screw close to the center of gravity of the electromagnetic valve, and the weight of the intake manifold becomes heavy.

### SUMMARY OF THE INVENTION

The present invention addresses the above disadvantages. Thus, it is an objective of the present invention to provide a vibration control supporter which employs a dual mount structure whereby a valve device is elastically supported at upper and lower portions of a rod shaped screwing body such as a bolt. The supporter restricts generation of an inclination of the valve device even though screwing torque of the screwing body is transmitted to an upper elastic body on an upper side of the screwing body.

To achieve the objective of the present invention, there is provided a vibration control supporter for supporting a valve device with vibration thereof controlled. The valve device has a valve port, which is inserted into a valve insertion hole formed in a fixing member with a sealing member made of elastic resin disposed between the valve insertion hole and the valve port. The supporter includes a rod shaped screwing body having a rod-like shape and including a male screw that is screwed into the fixing member, an upper elastic support part disposed at a first side portion of the screwing body that is away from the fixing member, and a lower elastic support part disposed at a second side portion of the screwing body that is close to the fixing member. An area of the fixing member in which the male screw is screwed is located adjacent to the valve device. The upper elastic support part has an upper elastic body made of elastic resin, and joins the screwing body and the valve device together by the upper elastic body. The lower elastic support part has a lower elastic body made of elastic resin and having a generally tubular shape, and joins the screwing body and the valve device together by the lower elastic body. In the upper elastic support part, when the screwing body is screwed into the fixing member, turning force of the screwing body is transmitted to the upper elastic body through a contact portion between the screwing body and the upper elastic body. The lower elastic support part further includes a collar made of a hard material, which is inserted into an inside of the lower elastic body. The collar has an insertion hole, through which the screwing body passes. The insertion hole includes a loosely fitted portion and a movement restricting portion. A clearance for canceling a manufacturing tolerance is formed between the loosely fitted portion and the screwing body. The movement restricting portion is in contact with the screwing body thereby to prevent movement of the collar.

### BRIEF DESCRIPTION OF THE DRAWINGS

The invention, together with additional objectives, features and advantages thereof, will be best understood from the following description, the appended claims and the accompanying drawings in which:

FIG. 1 is a side view illustrating an electromagnetic valve attached to an intake manifold according to an embodiment of the invention;

FIG. 2A is a sectional view illustrating a collar according to the embodiment; and

FIG. 2B is a bottom plan view illustrating the collar.

### DETAILED DESCRIPTION OF THE INVENTION

An upper side in the invention indicates a side that is away from a fixing member, and a lower side in the invention indicates a side that is close to the fixing member. They are not related to a direction in which a vibration control supporter is actually attached to the fixing member.

When the electromagnetic valve is long in a direction in which a valve port (part inserted into the intake manifold) of the electromagnetic valve is inserted, or the electromagnetic valve is heavy, for example, great inclination force is generated in the electromagnetic valve due to vibration and load applied to a radial direction of the electromagnetic valve. When the elastic body is provided on a valve port insertion-side of the electromagnetic valve, that is, near the intake manifold, there is a concern that the electromagnetic valve is inclined because the great inclination force produced in the electromagnetic valve cannot be absorbed in the elastic body. When the electromagnetic valve is inclined, the valve port of the electromagnetic valve is brought into contact with an inner wall of a valve insertion hole formed in the intake manifold. As a result, the malfunction of transmission of an operating sound of the electromagnetic valve to the intake manifold is caused.

In JP-U-7-41160, a position of a female screw into which the bolt is screwed is brought close to the center of gravity of the electromagnetic valve in order to bring an attachment position of the elastic body close to the center of gravity of the electromagnetic valve. However, the shape of the intake manifold becomes complicated to bring the female screw close to the center of gravity of the electromagnetic valve, and the weight of the intake manifold becomes heavy.

Accordingly, a bolt shaft of the bolt is lengthened to devise a vibration control supporter having a dual mount structure, in which the electromagnetic valve is elastically supported at two positions of the bolt (not a widely known art). The vibration control supporter includes an upper elastic support part and a lower elastic support part to firmly support the electromagnetic valve with its vibration controlled. An upper elastic body (grommet) is disposed at a portion of the bolt which is away from the intake manifold, and the upper elastic support part supports the electromagnetic valve through the upper elastic body. A lower elastic body (bush) is disposed at a portion of the bolt close to the intake manifold, and the lower elastic support part supports the electromagnetic valve through the lower elastic body.

In the upper elastic support part, a metal sleeve disposed between the upper elastic body and the bolt is not used, and the upper elastic body is directly pressed on the bolt in order to improve a vibrational absorption effect of the upper elastic body. More specifically, since a moderate compressibility is required of the upper elastic body, the upper elastic body is attached with the upper elastic body compressed between the bolt and the electromagnetic valve. Accordingly, when inserting the valve port into the intake manifold and screwing the bolt into the intake manifold, turning force (screw driving force) of the bolt is transmitted to the upper elastic body through a contact portion between the bolt and the upper elastic body. As a result, torsion is generated in the upper elastic body that is elastically deformed.

In the lower elastic support part, the moderate compressibility is given to the lower elastic body by inserting a metal collar into the inside of the lower elastic body having a tubular shape and pressing a metal washer formed at an upper part of the lower elastic body by fastening force of the bolt (Alternatively, the moderate compressibility may be given to the lower elastic body by inserting the collar into the inner side portion of the lower elastic body with the lower elastic body pressurized). The collar has a cylindrical part that is inserted into the inside of the lower elastic body, and an insertion hole through which the bolt is passed. The lower elastic body is supported by the collar.

An inner diameter size of the insertion hole of the collar may accord with an outside diameter size of the bolt (diameter of a portion of the bolt arranged in the insertion hole when the bolt is attached). However, a distance between an insertion position of the electromagnetic valve determined by inserting the valve port into the valve insertion hole and a fastening position of the bolt varies according to a manufacturing tolerance. Accordingly, when the inner diameter size of the insertion hole in the collar is made to accord with the outside diameter size of the bolt, the electromagnetic valve cannot be attached. As a result, by making the insertion hole in the collar larger enough than the outside diameter size of the bolt, a clearance which absorbs the tolerance may be formed between an inner diameter part of the insertion hole and the bolt.

In a case where the electromagnetic valve is attached to the intake manifold, when screwing torque of the bolt is applied to the upper elastic body and thereby the above torsion is generated in the upper elastic body, the lower elastic body and the collar of the lower elastic support part are movable toward a radial direction of the bolt because of the above clearance. Accordingly, the electromagnetic valve is rotated around a line connecting the valve port (specifically, a contact part between a sealing member formed on the valve port and a valve insertion hole) and the upper elastic body (specifically, a contact part between the upper elastic body and the bolt). When an upper part of the electromagnetic valve rotates around the valve port, the electromagnetic valve including the valve port is inclined. When the valve port is inclined and thereby the valve port is brought into direct contact with the intake manifold, the vibration of the electromagnetic valve is transmitted to the intake manifold, and the malfunction of the generation of the operating sound of the electromagnetic valve from the intake manifold is caused.

The present invention addresses the above disadvantages. Thus, it is an objective of the present invention to provide a vibration control supporter which employs a dual mount structure whereby a valve device is elastically supported at upper and lower portions of a rod shaped screwing body such as a bolt. The supporter restricts generation of an inclination of the valve device even though screwing torque of the screwing body is transmitted to an upper elastic body on an upper side of the screwing body.

A vibration control supporter of an embodiment of the invention supports an electromagnetic valve (an example of a valve device) with its vibration controlled. The electromagnetic valve has a valve port that is inserted into a valve insertion hole through a sealing member made of elastic resin. The valve insertion hole is formed in an intake manifold (an example of a suction member or a fixing member). The vibration control supporter includes a bolt (an example of a rod shaped screwing body) adjacent to the electromagnetic valve and having a male screw which is screwed into the intake manifold, an upper elastic support part joining the bolt and the electromagnetic valve on an upper side of the bolt away from the intake manifold through an upper elastic body (grommet) made of elastic resin, and a lower elastic support part joining the bolt and the electromagnetic valve on a lower side of the bolt close to the intake manifold through a lower elastic body (bush) made of elastic resin.

When the bolt is screwed into the intake manifold, in the upper elastic support part, turning force (screwing force) of the bolt is transmitted to the upper elastic body through a contact portion between the bolt and the upper elastic body. The lower elastic support part has a collar including metal (an example of a hard material) that is press-fitted to the inside of the generally tubed lower elastic body. The collar has an insertion hole into which the bolt is inserted. An insertion hole of the collar includes a loosely fitted portion (portion having a larger inner diameter than a diameter of the bolt) defining a clearance that absorbs a tolerance between the bolt and the loosely fitted portion, and a movement restricting portion (portion that generally accords with the bolt diameter) in contact with the bolt to prevent the movement of the color. Accordingly, two contradictory functions, that is, the absorption of the tolerance and the prevention of movement of the color are fulfilled.

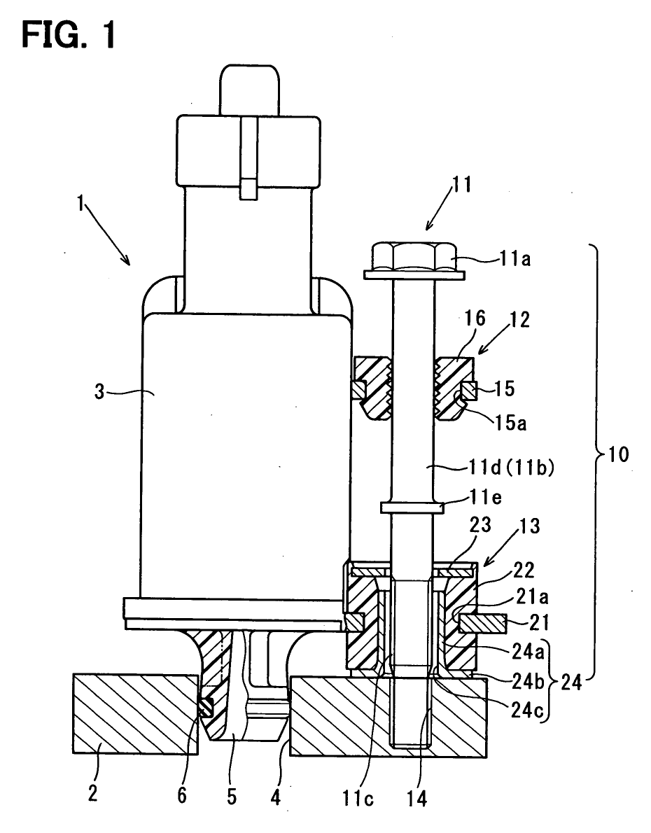

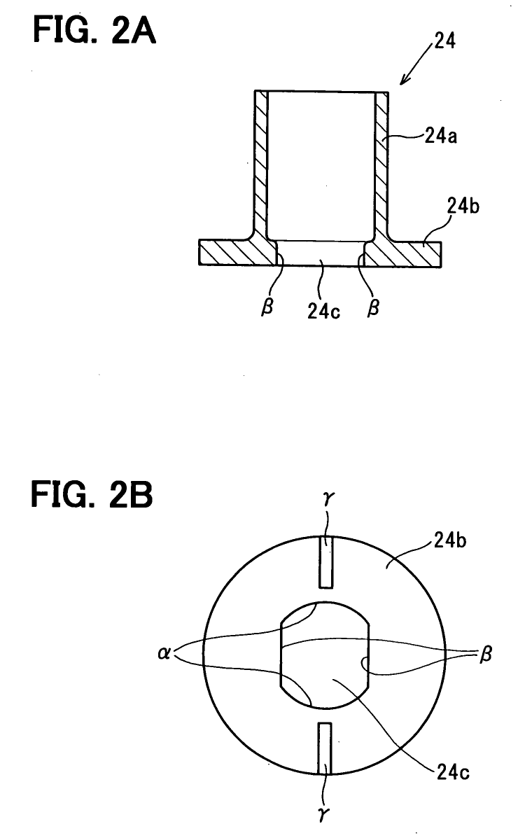

The embodiment, in which the vibration control supporter of the invention is applied to a supporting structure of an electromagnetic valve that is attached to an intake manifold (an example of a suction member defining a suction passage in an engine for vehicles), is described with reference to FIGS. 1 to 2B. An electromagnetic valve 1 of the embodiment regulates a degree of opening of a purging passage through which a canister tank that absorbs and holds purge fuel (gasified fuel) and a intake pipe which a negative pressure of intake air is generated communicate to control the suction quantity of purge fuel suctioned into the engine (purge flow control). The electromagnetic valve 1 is a known electromagnetic valve including a valve that opens/closes a purge passage and adjusts its opening degree and an electromagnetic actuator which drives the valve.

The electromagnetic valve 1 includes an electromagnetic valve main body 3 into which the electromagnetic actuator is incorporated, and a valve port 5 that is inserted into a valve insertion hole (connection hole for the electromagnetic valve 1) 4 of an intake manifold 2. A clearance between the valve port 5 and the valve insertion hole 4 is sealed with a sealing member (e.g., O ring) 6 made of elastic resin, which is attached on an outer circumference of the valve port 5. By disposing the sealing member 6 between the valve port 5 and the intake manifold 2, a direct contact between the electromagnetic valve 1 and the intake manifold 2 is prevented, and the electromagnetic valve 1 is attached to the intake manifold 2 using a vibration control supporter 10.

The vibration control supporter 10 includes a bolt 11 fastened on the inlet manifold 2. The vibration control supporter 10 includes an upper elastic support part 12 which supports the electromagnetic valve 1 in a floating manner at a portion of the bolt 11 which is away from the intake manifold 2, and a lower elastic support part 13 which supports the electromagnetic valve 1 in a floating manner at a portion of the bolt 11 which is closed to the intake manifold 2.

A screw hole (female screw) 14 is formed in the intake manifold 2 adjacent to the valve insertion hole 4. The screw hole 14 extends in the same direction (direction in which the valve port 5 is inserted) as the valve insertion hole 4. The bolt 11 includes a bolt head 11a having a hexagonal shape and engaging a fastening tool (e.g., hexagonal wrench) and a bolt shaft 11b extending long from the center of the bolt head 11a in an axial direction of the bolt head 11a. The bolt head 11a is formed at one end of the bolt shaft 11b. A male screw 11c is formed at the other end (leading end) of the bolt shaft 11b. The male screw 11c is screwed into the screw hole 14 formed in the intake manifold 2. The bolt shaft 11b between the male screw 11c and the bolt head 11a is formed as a round bar 11d having a round cross sectional surface, on which the male screw 11c is not formed. A bolt flange 11e is formed at a halfway portion of the round bar 11d in the axial direction. The bolt flange 11e pressurizes and compresses a metal washer 23 (described in greater detail hereinafter) formed in the lower elastic support part 13 in the axial direction when the bolt 11 is screwed into the screw hole 14 to be fastened to the intake manifold 2.

The upper elastic support part 12 includes only an upper elastic body 16 made of elastic resin. The upper elastic body 16 is attached to an upper stay 15 fixed to the electromagnetic valve main body 3 at a portion of the electromagnetic valve main body 3 which is away from the intake manifold 2. Accordingly, the upper elastic body 16 is arranged around the outer circumference of the round bar 11d at a portion of the round bar 11d that is a predetermined distance away from the intake manifold 2 in the axial direction of the bolt shaft 11b. The upper elastic body 16 is attached in an upper elastic body fitting hole 15a (e.g., round hole, C-shaped hole, or U-shaped hole) formed in the upper stay 15, and made of generally cylindrical elastic resin (e.g., Ethylene-Propylene diene terpolymer (EPDM)). A fitting groove, which is fitted into the upper elastic body fitting hole 15a, is formed on an outer circumferential surface of the upper elastic body 16. The upper elastic body 16 is attached around the outer circumference of the round bar 11d on a bolt head 11a-side of the bolt flange 11e. The upper elastic body 16 is radially pressurized between the upper elastic body fitting hole 15a and the round bar 11d, and thereby an appropriate compressibility (compressive force) is given to the upper elastic body 16. An inner diameter size of a hole of the upper elastic body 16, into which the round bar 11d is inserted, is smaller than an outside diameter size of the round bar 11d by a predetermined amount.

Since the inner diameter size of the upper elastic body 16 is smaller than the outside diameter size of the round bar 11d, turning force of the bolt 11 is transmitted to the upper elastic body 16 through a contact portion between the round bar 11d and the upper elastic body 16, when the bolt 11 is screwed into the screw hole 14. In the present embodiment, in order to reduce the turning force transmitted to the upper elastic body 16 from the bolt 11, a plurality of grooves is formed along a rotational sliding direction on an inner circumferential surface (contact surface with the round bar 11d) of the upper elastic body 16.

In the present embodiment, even when the bolt 11 is fastened into the screw hole 14, the bolt head 11a is not in contact with the upper elastic body 16. Alternatively, the bolt head 11a may pressurize the upper elastic body 16 with a predetermined amount of pressure in the axial direction when the bolt 11 is fastened into the screw hole 14. In this case, depressions and projections (not shown) formed from a plurality of grooves along the rotational sliding direction on of the bolt head 11a may desirably be disposed at a contact portion of the upper elastic body 16 with the bolt head 11a. Alternatively, a relief component (not shown) for relieving frictional force including a metal washer or the like may desirably be disposed between the upper elastic body 16 and the bolt head 11a.

The lower elastic support part 13 is attached to the lower stay 21, which is fixed to an intake manifold 2-side (valve port 5-side) of the electromagnetic valve main body 3, and includes a lower elastic body 22, the metal washer 23, and a collar 24. The lower elastic body 22 is attached in an lower elastic body fitting hole 21a (e.g., round hole, C-shaped hole, or U-shaped hole) formed in the lower stay 21, and made of generally cylindrical elastic resin (e.g., EPDM). A fitting groove, which is fitted into the lower elastic body fitting hole 21a, is formed on an outer circumferential surface of the lower elastic body 22. The metal washer 23 is a metal ring disc, which is attached on an upper portion of the lower elastic body 22 in FIG. 1. The metal washer 23 is made to pressurize the lower elastic body 22 in the axial direction (axial direction of the bolt shaft 11b) by the bolt flange 11e when the bolt 11 is fastened into the screw hole 14.

The collar 24 is made of metal such as iron, and includes a cylindrical portion 24a, which is inserted into an inner hole of the lower elastic body 22 in a direction from a lower side in FIG. 1, and a pedestal 24b having a flanged shape in contact with the intake manifold 2. An insertion hole 24c into which the bolt 11 is inserted is formed in a central portion of the pedestal 24b. When the lower elastic body 22 is pressurized by the bolt 11 through the metal washer 23, the appropriate compressibility (compressive force) is given to the lower elastic body 22 between the lower elastic body fitting hole 21a and the collar 24, since an inner diameter of the lower elastic body 22 is fixed by the cylindrical portion 24a. Alternatively, a moderate compressibility may be given to the lower elastic body 22 by inserting the collar 24 into an inner side portion of the lower elastic body 22 with the lower elastic body 22 pressurized, instead of the pressurization of the bolt 11.

When attaching the electromagnetic valve 1 to the intake manifold 2, a distance between a insertion point of the electromagnetic valve 1 determined by inserting the valve port 5 in the valve insertion hole 4 and a fastening position of the bolt 11 varies according to a manufacturing tolerance. Accordingly, when the inner diameter size of the insertion hole 24c of the collar 24 is made to accord with the outside diameter size of the bolt 11, the electromagnetic valve 1 cannot be attached to the intake manifold 2. Consequently, a clearance for compensating the tolerance may be formed between the bolt 11 and an inner diameter part of the insertion hole 24c by making the insertion hole 24c larger enough compared with the outside diameter size of the bolt 11.

As a result, the electromagnetic valve 1 is made in a rotatable condition around a line connecting a valve port 5 with the upper elastic body 16 within a range (within a range in which the bolt 11 is not in contact with the insertion hole 24c) of the clearance. For this reason, when screwing torque of the bolt 11 is applied to the upper elastic body 16 and thereby torsion is generated in the upper elastic body 16, the electromagnetic valve 1 is rotated and inclined within the range of the clearance, so that the valve port 5 is inclined. When the valve port 5 is inclined, the valve port 5 is brought into direct contact with an inner wall of the valve insertion hole 4, and the vibration which the electromagnetic valve 1 generates is transmitted to the intake manifold 2. As a result, a malfunction of the generation of an operating sound of the electromagnetic valve 1 is caused.

The vibration control supporter 10 of the embodiment employs the following means in order to avoid the above malfunction. As mentioned above, the vibration control supporter 10 employs a dual mount structure whereby the electromagnetic valve 1 is elastically supported at two places, that is, at the upper elastic support part 12 on the upper side of the bolt 11 and the lower elastic support part 13 on the lower side of the bolt 11. The screwing torque of the bolt 11 is transmitted to the upper elastic body 16 of the upper elastic support part 12. The metal collar 24 is inserted into the lower elastic body 22 of the lower elastic support part 13. The insertion hole 24c of the collar 24, into which the bolt 11 is inserted, includes a loosely fitted portion a that defines the clearance together with the bolt 11, which compensates the tolerance, and a movement restricting portion β that is in contact with the bolt 11 and prevents the movement of the collar 24.

The loosely fitted portion α is formed as a round hole which defines the clearance together with the bolt 11, and the clearance compensates the tolerance. A size of an inner diameter of the round hole formed into the loosely fitted portion a is set to be a sum (A+B) of a diameter A of the bolt 11 in the insertion hole 24c and a maximum manufacturing tolerance range B, or a sum (A+B+C) as a result of further adding an allowance C in a state in which the bolt 11 is fastened to the intake manifold 2. In the present embodiment, the loosely fitted portion α was formed from the round hole. Alternatively, other hole shapes such as a quadrilateral hole may be employed as long as the tolerance” is compensated.

The movement restricting portion β is in contact with the bolt 11 fastened to the intake manifold 2 and prevents the movement of the collar 24 and the lower elastic body 22. The movement restricting portion β is formed as a parallel width across flat in the insertion hole 24c. An opposite distance between the width across flat formed into the movement restricting portion β is set to be a sum (A+D) of the diameter A of the bolt 11 in the insertion hole 24c and an insertion clearance D (e.g., about 0.1 mm) of the bolt 11 in a state in which the bolt 11 is fastened to the intake manifold 2.

The collar 24 has a mark γ that indicates a direction of the loosely fitted portion α is formed in a position where the mark γ is recognized visually from the outside in a state in which the electromagnetic valve 1 is attached to the intake manifold 2 (specifically, in a state in which the bolt 11 is fastened to the intake manifold 2 and the electromagnetic valve 1 is joined to the intake manifold 2). The mark γ is formed on the pedestal 24b of the collar 24. The mark γ may be an additament by coloring or printing, or may be formed directly on the collar 24 in the form of a groove or a hole (hollow). In the present embodiment, the mark γ is given to the direction of the loosely fitted portion α. Alternatively, the mark γ may be given to a direction of the movement restricting portion β.

### ADVANTAGEOUS EFFECTS OF THE EMBODIMENT

In the present embodiment, the electromagnetic valve 1 and the bolt 11 are attached to the intake manifold. 2 in a state in which a straight line connecting two marks γ is directed to the valve port 5. Accordingly, when attaching the electromagnetic valve 1 to the intake manifold 2, the loosely fitted portion a (round hole) formed in the insertion hole 24c of the collar 24 compensates the manufacturing tolerance. Therefore, the bolt 11 is fitted into the screw hole 14 of the intake manifold 2 to screw the bolt 11 into the intake manifold 2 in a state in which the valve port 5 of the electromagnetic valve 1 is inserted into the valve insertion hole 4 of the intake manifold 2. When screwing in the bolt 11, the screwing torque of the bolt 11 is transmitted to the upper elastic body 16 through a contact portion between the bolt 11 and the upper elastic body 16, and thereby the force in a twisting direction is applied to the upper elastic body 16. Due to the torsion of the upper elastic body 16, the rotating tilt force with the valve port 5 being its center is applied to the electromagnetic valve 1.

The rotating tilt force applied to the electromagnetic valve 1 is also applied to the lower elastic support part 13 which supports the electromagnetic valve 1. Even though the moving force is transmitted to the collar 24 through the lower elastic body 22, the movement restricting portion β (width across flat) formed in the insertion hole 24c of the collar 24 is in contact with the bolt 11 to prevent the movement of the collar 24. Accordingly, since the movement of the lower elastic body 22 attached under pressure on the outer circumference of the collar 24 is also prevented, the lower elastic support part 13 prevents the rotating tilt of the electromagnetic valve 1. More specifically, the electromagnetic valve 1 is supported at the three points, that is, the sealing member 6 of the valve port 5, the upper elastic body 16 of the upper elastic support part 12, and the lower elastic body 22 of the lower elastic support part 13. As a result, the electromagnetic valve 1 cannot rotate at a tilt except for deformation of each elastic body (the sealing member 6, the upper elastic body 16, and the lower elastic body 22). Consequently, even though the force in the twisting direction is applied to the upper elastic body 16, the inclined attachment of the electromagnetic valve 1 is restricted. Thus, the malfunction of the direct contact between the valve port 5 and the valve insertion hole 4 is avoided, and accordingly the malfunction of the transmission of the vibration which the electromagnetic valve 1 generates to the intake manifold 2 is avoided.

In addition, the movement restricting portion β takes the form of the width across flat. As a result, even though the position of the bolt 11 varies in the insertion hole 24c according to the tolerance, the movement of the collar 24 and the lower elastic body 22 is certainly prevented at the time of the fastening of the bolt 11 because the bolt 11 is in contact with one of the widths across flat. Furthermore, by forming the mark γ indicating the direction of the loosely fitted portion α in the position where the mark γ is recognized visually from the outside in the state in which the electromagnetic valve 1 is attached to the intake manifold 2, a direction in which the collar 24 is attached is learned although the electromagnetic valve 1 is attached on the intake manifold 2.

### MODIFICATIONS

In the above embodiment, the intake manifold 2 serves as an example of the suction member defining the suction passage. Alternatively, the invention may be applied to a case in which the electromagnetic valve 1 is disposed in a suction member (intake pipe) on an upstream side of the intake manifold 2. Furthermore, the suction member serves as an example of a fixing member. However, the fixing member is not limited to the suction member and the invention may be applied to a valve device attached to another fixing member.

In the above embodiment, the invention is applied to the electromagnetic valve 1 which performs the purge flow control. Instead, the invention may be applied to the electromagnetic valve 1 which performs another fluid control. In addition, the electromagnetic valve 1 serves as an example of the valve device. Alternatively, the invention may be applied to the valve devices using other actuators, such as different electric actuators (e.g., piezo actuator) from the electromagnetic actuator, or fluid actuators (e.g., hydraulic actuator). In the above embodiment, the transmission of the vibration of the valve device (electromagnetic valve 1) to the fixing member (intake manifold 2) is prevented. Instead, the invention may be applied in order to prevent the transmission of vibration, which is transmitted to the fixing member, to the valve device.

Additional advantages and modifications will readily occur to those skilled in the art. The invention in its broader terms is therefore not limited to the specific details, representative apparatus, and illustrative examples shown and described.

What is claimed is:

1. A vibration control supporter for supporting a valve device with vibration thereof controlled, wherein the valve device has a valve port, which is inserted into a valve insertion hole formed in a fixing member with a sealing member made of elastic resin disposed between the valve insertion hole and the valve port, the supporter comprising:
a rod shaped screwing body having a rod-like shape and including a male screw that is screwed into the fixing member, wherein an area of the fixing member in which the male screw is screwed is located adjacent to the valve device;
an upper elastic support part disposed at a first side portion of the screwing body that is away from the fixing member, wherein the upper elastic support part has an upper elastic body made of elastic resin, and joins the screwing body and the valve device together by the upper elastic body; and
a lower elastic support part disposed at a second side portion of the screwing body that is close to the fixing member, wherein the lower elastic support part has a lower elastic body made of elastic resin and having a generally tubular shape, and joins the screwing body and the valve device together by the lower elastic body, wherein:
in the upper elastic support part, when the screwing body is screwed into the fixing member, turning force of the screwing body is transmitted to the upper elastic body through a contact portion between the screwing body and the upper elastic body;
the lower elastic support part further includes a collar made of a hard material, which is inserted into an inside of the lower elastic body;
the collar has an insertion hole, through which the screwing body passes;
the insertion hole includes a loosely fitted portion and a movement restricting portion;
a clearance for canceling a manufacturing tolerance is formed between the loosely fitted portion and the screwing body; and
the movement restricting portion is in contact with the screwing body thereby to prevent movement of the collar.

2. The vibration control supporter according to claim 1, wherein the movement restricting portion includes parallel width across flats, a distance between which is a sum of a size of a diameter of the screwing body disposed in the insertion hole and a size of an insertion clearance of the screwing body in a state in which the screwing body is screwed into the fixing member.

3. The vibration control supporter according to claim 1, wherein:
the collar further includes a mark at a position on the collar that is visually recognizable from an outside in a state, in which the screwing body is screwed into the fixing member and the valve device is inserted into the fixing member; and
the mark indicates a direction of one of the loosely fitted portion and the movement restricting portion.

4. The vibration control supporter according to claim 1, wherein:
the fixing member is an air intake member defining an intake passage in an automotive engine; and
the valve device is an electromagnetic valve, which is configured to perform purge flow control, whereby an amount of purge fuel suctioned into the engine is controlled.
